(19) United States
(12) Patent Application Publication
(10) Pub. No.: US 2017/0116005 A1
(43) Pub. Date: Apr. 27, 2017

(54) INFORMATION PROCESSING SYSTEM, INFORMATION PROCESSING APPARATUS, METHOD OF CONTROLLING INFORMATION PROCESSING APPARATUS

(71) Applicant: FUJITSU LIMITED, Kawasaki-shi (JP)

(72) Inventor: Tetsuji Oya, Kawasaki (JP)

(73) Assignee: FUJITSU LIMITED, Kawasaki-shi (JP)

(21) Appl. No.: 15/279,509

(22) Filed: Sep. 29, 2016

(30) Foreign Application Priority Data
Oct. 22, 2015 (JP) 2015-207920

(51) Int. Cl. G06F 9/445; G06F 9/44

(52) U.S. Cl. CPC G06F 9/44505; G06F 9/4406

(57) ABSTRACT

It is provided an information processing system including information processing apparatuses which distribute a setting value. The first information processing apparatus executes a first storing process for storing information of first time corresponding to a first setting value distributed to the first information processing apparatus, a first receiving process for receiving information of second time corresponding to a second setting value from a second information processing apparatus which distributes the second setting value, a first determination process for determining whether the first time is earlier than the second time, a first obtaining process for obtaining the second setting value from the second information processing apparatus when the first determination process determines that the first time is earlier than the second time, and a first setting process for setting the obtained second setting value in place of the first setting value in the first information processing apparatus.

### CROSS-REFERENCE TO RELATED APPLICATION

This application is based upon and claims the benefit of priority of the prior Japanese Patent Application No. 2015-207920, filed on Oct. 22, 2015, the entire contents of which are incorporated herein by reference.

### FIELD

The embodiments discussed herein are related to an information processing system, an information processing apparatus and a method of controlling information processing apparatus.

### BACKGROUND

In information processing systems such as multi-cluster computer systems and High Performance Computing (HPC) systems, techniques are employed for aligning setting values for firmware such as Basic Input Output System (BIOS) and Baseboard Management Controller (BMC) of the computers connected with each other (See patent documents 1 and 2).

The following patent document describes conventional techniques related to the techniques described herein.

### PATENT DOCUMENT

[Patent document 1] Japanese Laid-Open Patent Publication No. 2001-175562

[Patent document 2] Japanese Laid-Open Patent Publication No. 2003-316676

### SUMMARY

According to one embodiment, it is provided an information processing system including a plurality of information processing apparatuses each of which distributes a setting value. A first information processing apparatus of the plurality of information processing apparatuses comprises a first processor and first memory storing instructions for causing the first processor. The first processor executes a first storing process for storing information of first time corresponding to a first setting value distributed to the first information processing apparatus, a first receiving process for receiving information of second time corresponding to a second setting value from a second information processing apparatus of the plurality of information processing apparatuses which distributes the second setting value, a first determination process for determining whether the first time is earlier than the second time, a first obtaining process for obtaining the second setting value from the second information processing apparatus when the first determination process determines that the first time is earlier than the second time, and a first setting process for setting the obtained second setting value in place of the first setting value in the first information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an information processing system according to an embodiment;

FIG. 2 is a diagram illustrating an example of a configuration of a computer;

FIG. 3 is a diagram illustrating a management information table according to an embodiment;

FIG. 4 is a diagram illustrating an example of a flowchart performed by a computer according to an embodiment;

FIG. 5 is a diagram illustrating an example of a flowchart performed by a computer according to an embodiment;

FIG. 6 is a diagram illustrating an example of a flowchart performed by a computer according to an embodiment;

FIG. 7 is a diagram illustrating a management information table according to an embodiment;

FIG. 8 is a diagram illustrating a management information table according to an embodiment;

FIG. 9 is a diagram illustrating an example of a flowchart performed by a computer according to an embodiment;

FIG. 10 is a diagram illustrating a management information table according to an embodiment;

FIG. 11 is a diagram illustrating a management information table according to an embodiment;

FIG. 12 is a diagram illustrating an example of a flowchart performed by a computer according to an embodiment;

FIG. 13 is a diagram illustrating an example of a flowchart performed by a computer according to an embodiment;

FIG. 14 is a diagram illustrating a management information table according to an embodiment;

FIG. 15 is a diagram illustrating an example of a flowchart performed by a computer according to an embodiment;

FIG. 16 is a diagram illustrating an example of a flowchart performed by a computer according to an embodiment;

FIG. 17 is a diagram illustrating an example of a flowchart performed by a computer according to an embodiment;

FIG. 18 is a diagram illustrating a management information table according to an embodiment;

FIG. 19 is a diagram illustrating a management information table according to an embodiment;

FIG. 20 is a diagram illustrating a management information table according to an embodiment;

FIG. 21 is a diagram illustrating a management information table according to an embodiment;

FIG. 22 is a diagram illustrating an example of a flowchart performed by a computer according to an embodiment; and

FIG. 23 is a diagram illustrating an example of a flowchart performed by a computer according to an embodiment.

### DESCRIPTION OF EMBODIMENTS

When the techniques as described above are employed, common setting values are distributed to a plurality of computers in the information processing system. It is noted that the setting values for the firmware such as BIOS and BMC can be changed in any one of the computers at an arbitrary time. Therefore, when different computers distribute different setting values in the system, computers which receive the distributed different setting values cannot determine to which setting values preference should be given. Embodiments are described below with reference to the drawings. Configurations of the following embodiment are exemplifications, and the present apparatus is not limited to the configurations of the embodiment.

### First Embodiment

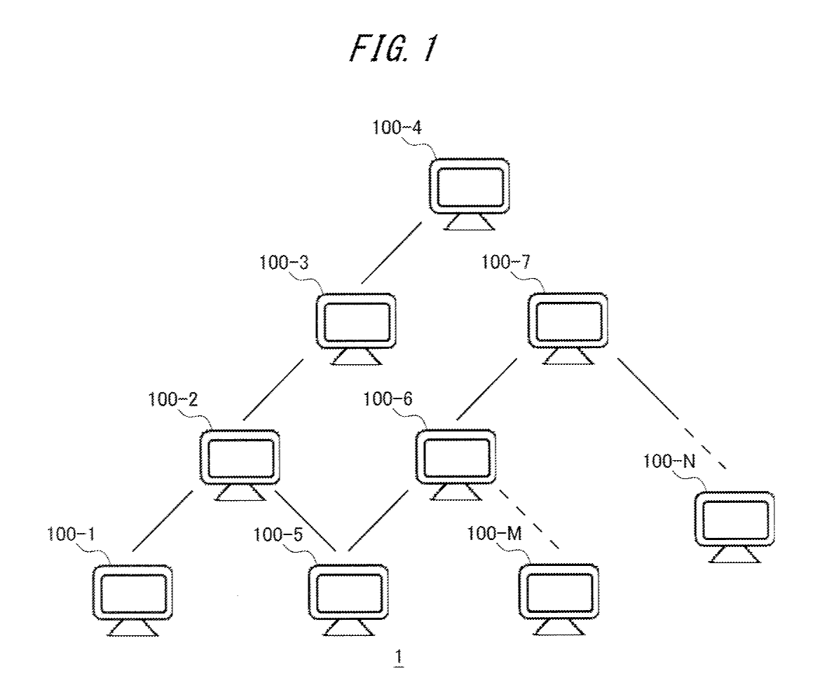

An information processing system 1 according to the first embodiment is described below. As illustrated in FIG. 1, the information processing system according to the present embodiment includes a plurality of computers 100-N (N=1, 2, 3 . . . ) connected with each other to form a tree-style network. It is noted that the configuration as illustrated in FIG. 1 is an example and other style connection configurations such as mesh-style, star-style and bus-style can be employed instead of the tree-style. It is noted that the computers 100-N are examples of the information processing apparatuses. In addition, the computers 100-N are merely referred to as computer(s) 100 in the following descriptions.

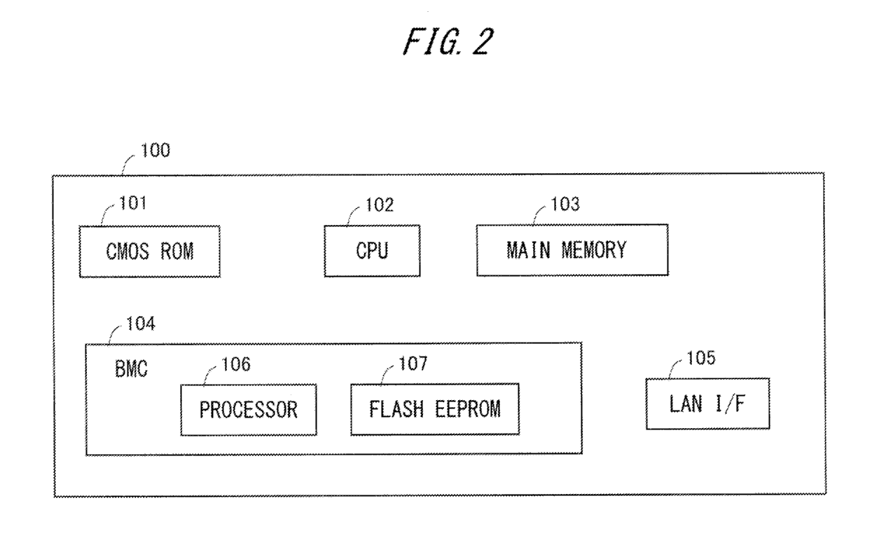

FIG. 2 illustrates an example of a configuration of the computer 100. As illustrated in FIG. 2, the computer 100 includes a Complementary Metal Oxide Semiconductor Read-Only Memory (CMOS ROM) 101, a Central Processing Unit (CPU) 102, Main Memory 103, a Baseboard Management Controller (BMC) 104 and a Local Area Network (LAN) interface (I/F) 105. In addition, the BMC 104 includes a processor 106 and Flash Electrically Erasable Programmable Read-Only Memory (Flash EEPROM) 107.

The CMOS ROM 101 stores a BIOS program for operating the BIOS and BIOS setting values. The BIOS setting values are setting values related to the input and output of data of the hardware in the computer 100 such as values for setting operations of the CPU 102 and the main memory 103 etc. The main memory 103 stores data used in the programs executed by the CPU 102 and the processes performed by the CPU 102.

The BMC 104 controls various processes as described below. The BMC 104 includes a processor 106 dedicated for the BMC 104 which is independent from the CPU 102 of the computer 100. The processor 106 receives information of the electric power consumptions and the temperatures of the sensors provided in the computer 100. In addition, the processor 106 performs various processes for monitoring the operations of the hardware in the computer 100. The Flash EEPROM 107 stores a BMC program and BMC setting values for operating the BMC 104. The BMC setting values are values for defining thresholds for determining voltage errors and temperature errors in the computer 100. In addition, the BMC values are values for defining the operations of the computer 100 for determining, for example, whether the computer 10 is powered off when an error occurs. It is noted that a BIOS setting value or a BMC setting value is an example of a setting value. Further, the Flash EEPROM 107 is an example of a storing unit.

The BIOS setting values and the BMC setting values are preset in the computer 100 according to the system configurations of the information processing system 1 when in the information processing system 1 is introduced. Specifically, a user of the information processing system 1 uses an input interface such as a mouse and a keyboard of a computer 100 and manually inputs BIOS setting values and BMC setting values into the computer 100. For example, when BIOS setting values and BMC setting values are input into the computer 100-N, the computer 100-N stores the input BIOS setting values and the input BMC setting values in the CMOS ROM 101 and the Flash EEPROM 107, respectively. In addition, the computer 100-N distributes the input BIOS setting values and the input BMC setting values to the other computers 100-M (M≠N; M=1, 2 . . . ). The details of processes performed by the computer 100 are described later.

The LAN I/F 105 is an interface for connecting with the other computers in the information processing system 1. In the present embodiment, a unique Internet Protocol (IP) address which distinguishes from the IP addresses of the LAN I/Fs of the other computers in the information processing system 1 is allocated to the LAN I/F 105 of the computer 100. It is noted that the user of the information processing system 1 can manually allocate the IP address to the LAN I/F 105 of the computer 100 by using the input interface of the computer 100. Alternately, the user of the information processing system 1 can use a Dynamic Host Configuration Protocol (DHCP) server to automatically perform the allocation of the IP addresses to the LAN I/Fs. Since the automatic allocation of the IP addresses using the DHCP server is a conventional technique, the details of the technique are omitted here.

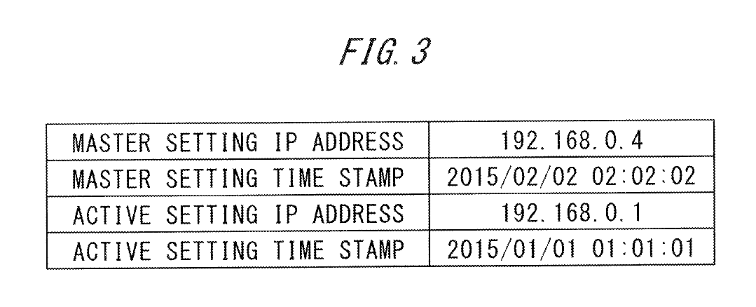

FIG. 3 illustrates an example of a management information table stored in the Flash EEPROM 107 in the present embodiment. The management information table stores the BIOS setting values and the BMC setting values. Specifically, the management information table includes fields such as master setting IP address, master setting time stamp, active setting IP address and active setting time stamp. It is noted that the active setting time stamp is an example of time information.

In the present embodiment, the user of the information processing system 1 inputs the BIOS setting values and the BMC setting values into a computer 100 in the information processing system 1. When the BIOS setting values and the BMC setting values are input into the computer 100, the computer 100 stores the IP address of the LAN I/F 105 in the “master setting IP address” field. The computer in which an IP address is stored in the “master setting IP address” field in the management information table as illustrated in FIG. 3 becomes a master computer. For example, when the computer 100-N becomes a master computer, the computer 100-N takes a role of distributing the BIOS setting values and the BMC setting values input into the computer 100-N by the user to the other computers 100-M in the information processing system 1. It is noted that when the BIOS setting values and the BMC setting values are not input into any one of the computers 100 in the information processing system 1, the value stored in the “master setting IP address” field in the computers 100 is “None”. Namely, any one of the computers 100 is not a master computer in the initial condition of the information processing system 1.

The “master setting time stamp” field in the management information table stores time when the BIOS setting values and the BMC setting values are input by the user of the information processing system 1, for example. It is noted that when the BIOS setting values and the BMC setting values are not input into anyone of the computers 100 in the information processing system 1, the value stored in the “master setting time stamp” field in the computers 100 is “None”.

The “active setting IP address” field in the management information table stores an IP address of a master computer which distributes the BIOS setting values and the BMC setting values set in the computer 100. For example, when the computer 100-N is a master computer, the computers 100-M as the destinations of the distribution of the BIOS setting values and the BMC setting values obtains the BIOS setting values and the BMC setting values from the computer 100-N. The computer 100-M sets the obtained BIOS setting values and the obtained BMC setting values in the computer 100-M itself and stores the IP address of the computer 100-N in the “active setting IP address” field in the computer 100-M. Therefore, the value stored in the “active setting IP address” field represents a master computer which distributes the BIOS setting values and the BMC setting values currently set in the computer 100.

The “active setting time stamp” field in the management information table stores time when the BIOS setting values and the BMC setting values currently set in the computer 100 are set in the master computer which distributes the BIOS setting values and the BMC setting values. It is noted that the time when the BIOS setting values and the BMC setting values are set in the master computer means the time when the user of the information processing system 1 input the BIOS setting values and the BMC setting values into the master computer and can represent the time when the BIOS setting values and the BMC setting values are generated. When the computer 100-N is a master computer, the computers 100-M as the distribution destinations of the BIOS setting values and the BMC setting values receive the data of the time stored in the “active setting time stamp field in the master computer in addition to the BIOS setting values and the BMC setting values. Therefore, when the computers 100-M receives the BIOS setting values and the BMC setting values and the data of the time, the computers 100-M compare the time indicated by the received data with the time currently stored in the “active setting time stamp” field to determine which of BIOS setting values and the BMC setting values received from the master computer or BIOS setting values and the BMC setting values currently set in the computers 100-M are more recent.

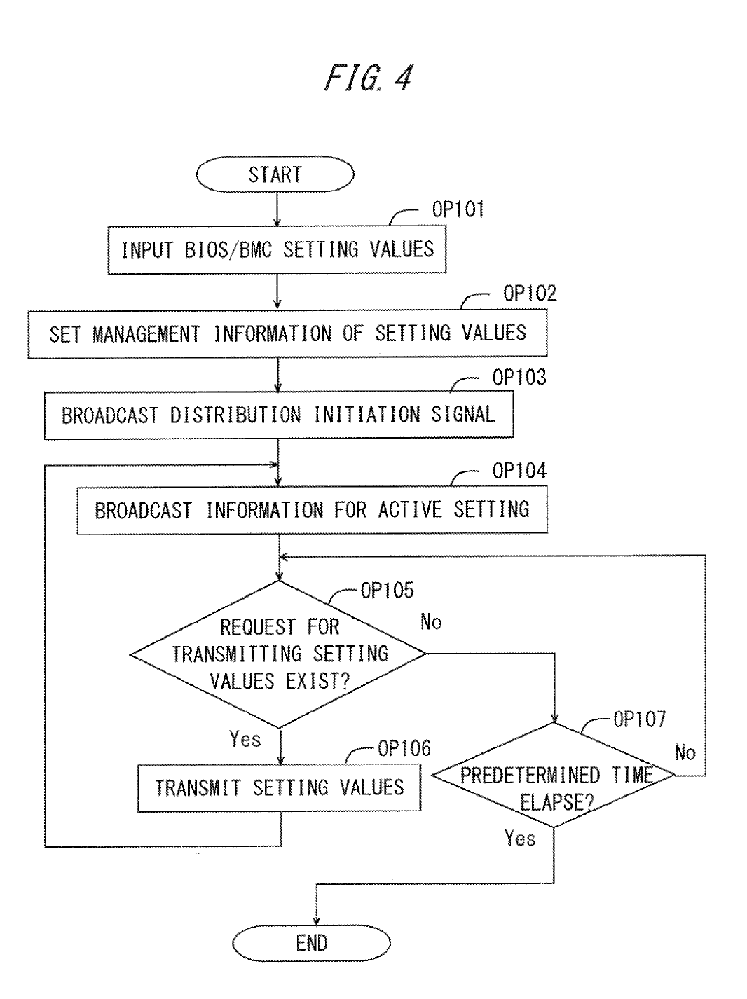

Next, the processes performed by the computer 100-N in the present embodiment are described below. FIG. 4 illustrates an example of a flowchart of processes performed by the computer 100-N when the computer 100-N sets BIOS setting values and BMC setting values for the first time in the present embodiment. It is noted that the values stored in the “master setting IP address” field, the “master setting time stamp” field, the “active setting IP address” field and the “active setting time stamp” field in the management information table stored in the Flash EEPROM 107 of the computer 100-N are “None”.

In OP101, the BMC 104 of the computer 100-N accepts the input of BIOS setting values and BMC setting values via the input interface from the user of the information processing system 1. Next, the process of the BMC 104 proceeds to OP102.

In OP102, the BMC 104 stores the input BIOS setting values and the input BMC setting values in the Flash EEPROM 107 and the CMOS ROM 101, respectively. Therefore, the settings of the BIOS setting values and the BMC setting values in the computer 100-N are completed. In addition, the BMC 104 stores the IP address allocated to the LAN I/F 105 of the computer 100-N and the time when the BIOS setting values and the BMC setting values are input into the computer 100-N in OP101 in the “master setting IP address” field and the “master setting time stamp” field, respectively, in the management information table of the BIOS setting values and the BMC setting values stored in the EEPROM 107. Further, the BMC 104 stores the IP address stored in the “master setting IP address” field and the time stored in the “master setting time stamp” field in the “active setting IP address” field and the “active setting time stamp” field, respectively. It is noted that the time when the BIOS setting values and the BMC setting values are input into the computer 100-N can be determined by using a real-time clock of the processor 106, for example.

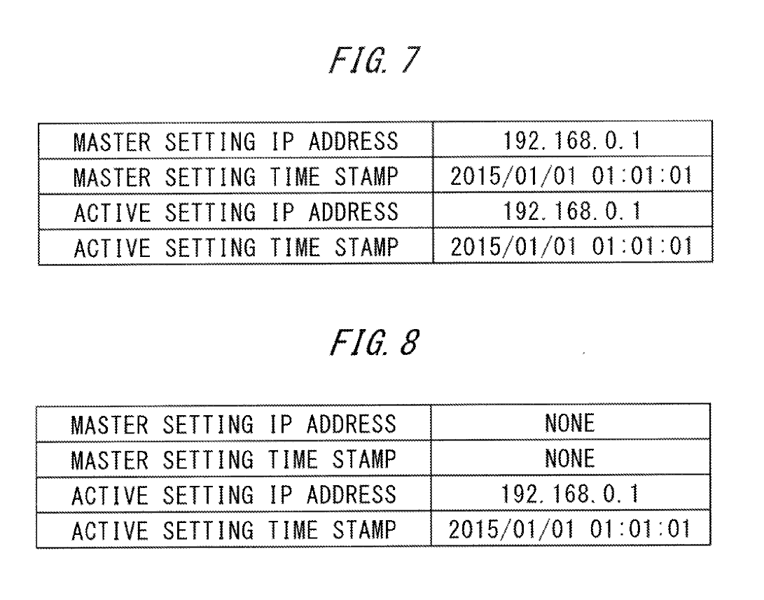

FIG. 7 illustrates an example of a state in which each value as described above is stored in the management information table in OP102. As illustrated in FIG. 7, the same IP address is stored in the “master setting IP address” field and the “active setting IP address” field and the same time is stored in the “master setting time stamp” field and the “active setting time stamp” field in OP102.

Next, the BMC 104 performs broadcast transmission of a distribution initiation signal for initiating the distribution to the other computers 100-M in the information processing system 1 via the LAN I/F 105 (OP103). The distribution initiation signal is described below. It can be assumed in the present embodiment that there are a plurality of master computers in the information processing system 1 because different BIOS setting values and different BMC setting values are input into different computers in the information processing system 1. In this case, the distribution suspension signal for suspending the distribution is broadcasted from each master computer to the computers other than the master computer. When the computers receive the distribution suspension signal, the computers suspends the distribution of the BIOS setting values and the BMC setting values of the master computer. In addition, when the computer which suspends the distribution receives the distribution initiation signal, the computer reinitiates the distribution of the BIOS setting values and the BMC setting values of the master computer. In this manner, the distribution initiation signal is used to instruct a computer which receives the distribution suspension signal and suspends the distribution to reinitiate the distribution. It is noted that when a computer which does not suspend the distribution receives the distribution initiation signal, the computer discards the received distribution initiation signal.

Next, the BMC 104 broadcasts each value stored in the “active setting IP address” field and the “active setting time stamp” field in the management information table (hereinafter, the values are referred to as “information for active setting”) via the LAN I/F 105 (OP104). In addition, the BMC 104 initiates in OP104 processes for measuring the time elapsed since the BMC 104 transmits the information for active setting. It is noted that the time measuring processes can be performed by using a conventional technique such as a timer (not illustrated).

When the computers 100-M receives the broadcasted information for active setting in OP104, the computers 100-M compare the value of the “active setting time stamp” included in the received information for active setting with the value stored in the “active setting time stamp” field in the management information table in the own computers 100-M. When the computers 100-M determines that the time represented by the value stored in the “active setting time stamp” field in the management information table is earlier than the time represented by the value of the “active setting time stamp” included in the received information for active setting, the computers 100-M request the computer 100-N for the BIOS setting values and the BMC setting values.

The BMC 104 of the computer 100-N determines whether the computer 100-N receives the request for the BIOS setting values and the BMC setting values from the computer 100-M (OP105). When the computer 100-N receives the request for the BIOS setting values and the BMC setting values from the computer 100-M (OP105: Yes), the process of the BMC 104 proceeds to OP106. On the other hand, the computer 100-N does not receive the requests for the BIOS setting values and the BMC setting values from the computers 100-M (OP105: No), the process of the BMC 104 proceeds to OP107.

In OP106, the BMC 104 transmits the BIOS setting values and the BMC setting values stored in the CMOS ROM 101 and the Flash EEPROM 107 to the computer 100-M which requests the computer 100-N for the BIOS setting values and the BMC setting values. The BMC 104 performs the processes in OP105 and OP106 to transmit the BIOS setting values and the BMC setting values to the first computer from which the BMC 104 receives the request for the BIOS setting values and the BMC setting values. It is noted here that the BMC 104 performs the processes in OP105 and OP106 as an example of a first distribution process for distributing a third setting value to an information processing apparatus when an information processing apparatus receives a response for the information of the third time from the information processing apparatus.

In the present embodiment, it can be assumed that the master computer 100-N receives requests for transmitting the BIOS setting values and the BMC setting values from a plurality of computers 100-M. Therefore, the master computer 100-N can transmit the BIOS setting values and the BMC setting values not only to the first computer from which the BMC 104 receives the request for the BIOS setting values and the BMC setting values but also to the other computers 100-M from which the BMC 104 receives the request for the BIOS setting values and the BMC setting values. When the BMC 104 transmits the BIOS setting values and the BMC setting values in OP106, the process of the BMC returns to OP105.

In OP107, the BMC 104 determines whether a predetermined time elapses since the time measuring is initiated in OP104. When the BMC 104 determines that the predetermined time elapses since the time measuring is initiated (OP107: Yes), the BMC assumes that the other computers 100 do not request the transmission of the BIOS setting values and the BMC setting values and terminates the processes in the flowchart. On the other hand, when the BMC 104 determines that the predetermined time does not elapse since the time measuring is initiated (OP107: No), the BMC returns the process to OP105 to accept a request for the transmission of the BIOS setting values and the BMC setting values from the other computers 100.

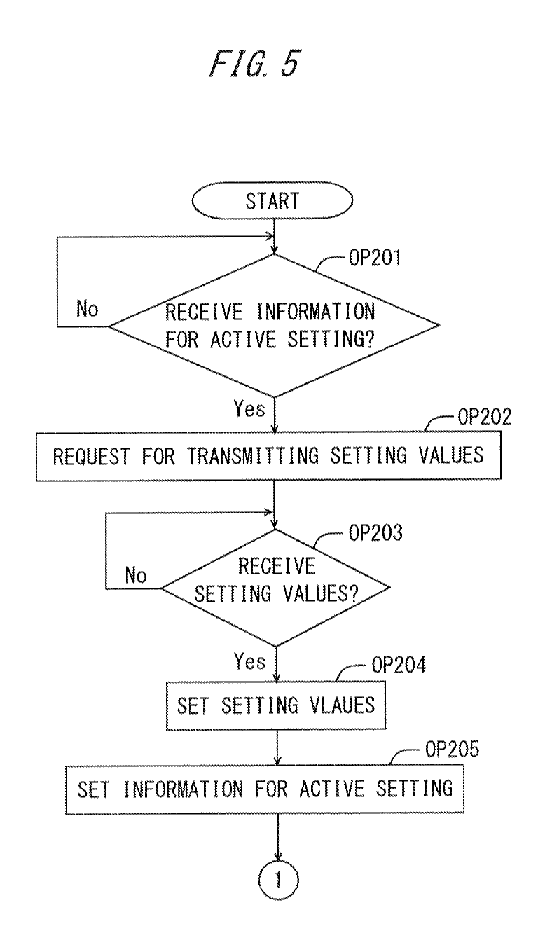

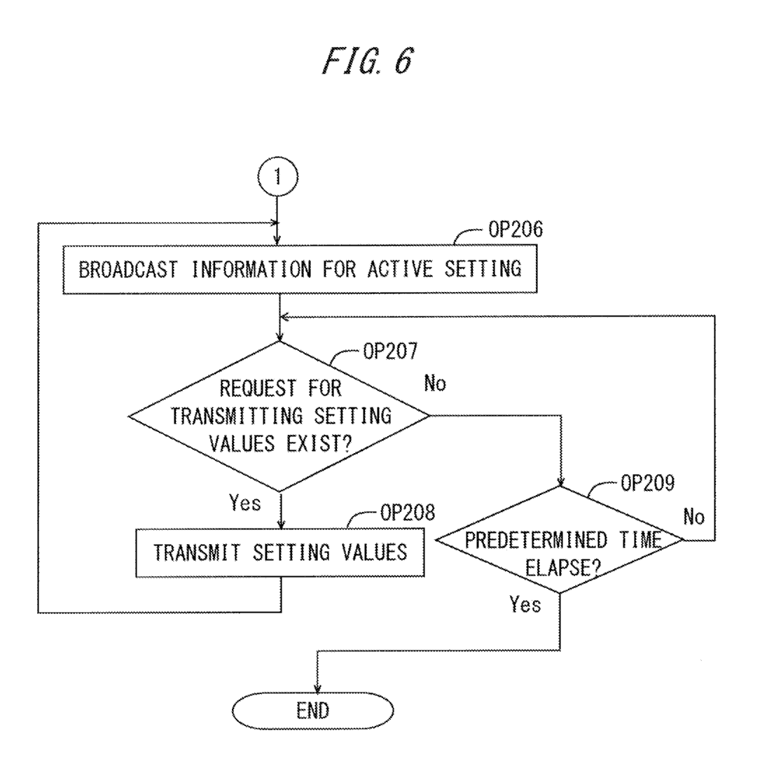

FIGS. 5 and 6 illustrate a flowchart of processes performed by the computers 100-M. It is noted that “1” in FIG. 5 is connected with “1” in FIG. 6. In addition, it is assumed that the computer 100-N transmits the information for active setting to the computer 100-M. In OP201, the BMC 104 of the computer 100-M determines whether the computer 100-M receives information for active setting from any one of the other computers in the information processing system 1. When the BMC 104 determines that the computer 100-M receives the information active setting (OP201: Yes), the process of the BMC 104 proceeds to OP202. When the BMC 104 determines that the computer 100-M does not receive the information active setting (OP201: No), the BMC 104 returns the process to OP201. Although FIG. 5 illustrates that the processes in OP201 are repeated endlessly, the BMC 104, in practice, detects the reception of the information active setting in the program executed by the BMC 104 when the information for active setting is received by the LAN I/F 105.

In OP202, the BMC 104 requests the computer 100-N which transmits the information for active setting for transmitting the BIOS setting values and the BMC setting values set in the computer 100-N to the computer 100-M. The BMC 104 stores the BIOS setting values and the BMC setting values received from the computer 100-N in the CMOS ROM 101 and the Flash EEPROM 107 of the computer 100-M, respectively (OP204). In addition, the BMC 104 stores each value stored in the “active setting IP address” field and the “active setting time stamp” field in the management information table stored in the EEPROM 107 (OP205). Specifically, the computers 100 which receive the BIOS setting values and the BMC setting values stores the IP address and the time received from the master computer in OP104 in the “active setting IP address” field and the “active setting time stamp” field, respectively.

FIG. 8 illustrates an example of a management information table stored in the Flash EEPROM 107 of the computer 100 which obtains the BIOS setting values and the BMC setting values in OP106. FIG. 8 illustrates the management information table in the computer 100 which receives the BIOS setting values and the BMC setting values from the master computer 100 in which the management information table illustrated in FIG. 7 is stored. As illustrated in FIGS. 7 and 8, the same values are stored in the “active setting IP address” field and the “active setting time stamp” field in each management information table in the master computer 100 and the computer 100 which obtains the BIOS setting values and the BMC setting values from the master computer 100. This means that the same BIOS setting values and the same BMC setting values are set in the master computer 100 and the computer 100 as the destination of the distribution of the BIOS setting values and the BMC setting values.

Since the processes in OP206 to OP209 are the same as the processes in OP104 to OP107 in FIG. 4, the details of the processes in OP206 to OP209 are omitted here. Therefore, the computer 100-M performs the processes in the flowchart to set the BIOS setting values and the BMC setting values which are set in the master computer 100-N in the own computer 100-M. In addition, the computer 100-M distributes the BIOS setting values and the BMC setting values to the other computers in the information processing system 1. As a result, the BIOS setting values and the BMC setting values which are set in the master computer 100-N are set in the computers in the information processing system 1.

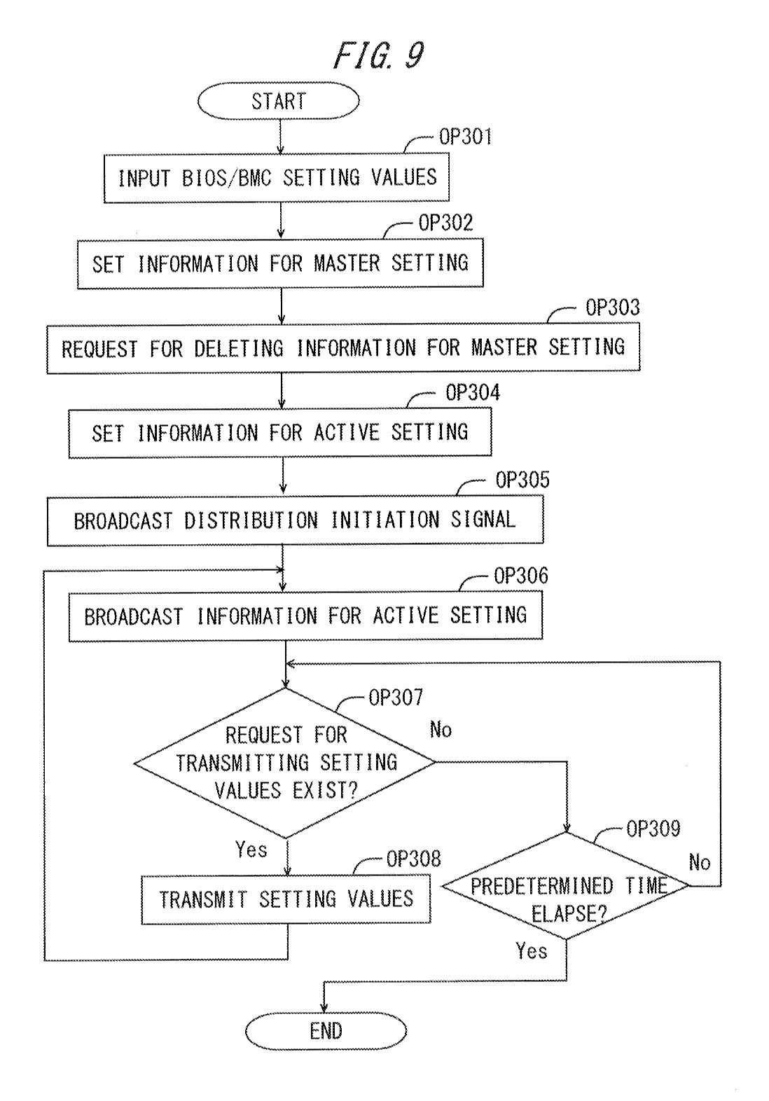

Next, the descriptions are provided with reference to the flowchart in FIG. 9 regarding the processes performed by the computer 100-N when new BIOS setting values and new BMC setting values are input into the computer 100-N in which BIOS setting values and BMC setting values have already been set. It is assumed here that the BIOS setting values and the BMC setting values distributed by the computer 100-M have been set in the computer 100-N. In addition, it is assumed in the processes in the flowchart that each value stored in the management information table in the computer 100-N is as illustrated in FIG. 8 when the computer 100-N initiates the processes in the flowchart in FIG. 9.

The values stored in the “master setting IP address” field and the “master setting time stamp” in the management information table stored in the Flash EEPROM 107 of the computer 100-N are “None” as illustrated in FIG. 8. In addition, an IP address and time are stored in the “active setting IP address” field and the “active setting time stamp” field, respectively.

In OP301, the BMC 104 of the computer 100-N accepts the input of BIOS setting values and BMC setting values via the input interface by the user of the information processing system 1. Next, the process of the BMC 104 proceeds to OP302.

In OP302, the BMC 104 stores the input BIOS setting values and the input BMC setting values in the CMOS ROM 101 and the Flash EEPROM 107, respectively. In addition, the BMC 104 stores the IP address allocated to the LAN I/F 105 of the computer 100-N in the “master setting IP address” field in the management information table. Further, the BMC 104 stores the time when the BIOS setting values and the BMC setting values are input in OP301 in the “master setting time stamp” in the management information table. The computer 100-N in which values are stored in the “master setting IP address” field and the “master setting time stamp” field becomes a master computer which distributes the BIOS setting values and the BMC setting values to the other computers.

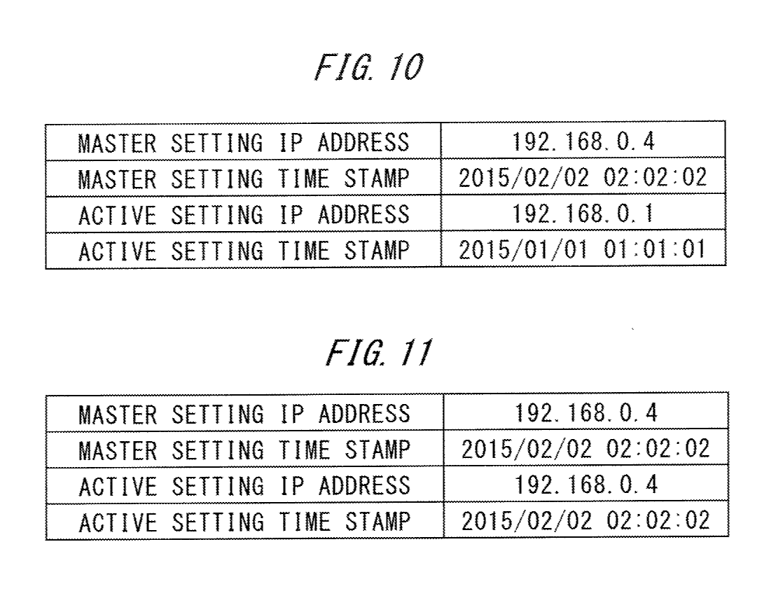

FIG. 10 illustrates an example of a state in which each value is stored in the management information table in OP302. As illustrated in FIG. 10, the time when the BIOS setting values and the BMC setting values are input in OP301 is stored in the “master setting time stamp” field in OP302. In addition, the time stored in the “active setting time stamp” field in the management information table in the master computer 100-M which distributes the BIOS setting values and the BMC setting values set in the computer 100-N before the processes in the flowchart are initiated is stored in the “active setting time stamp” field. Namely, the time stored in the “active setting time stamp” field is earlier than the time stored in the “master setting time stamp” field.

The BMC 104 instructs the computer 100-M represented by the IP address in the “active setting IP address” field to delete each value stored in the “master setting IP address” field and the “master setting time stamp” field in the management information table in the computer 100-M. It is noted that the instruction for deleting each value stored in the “master setting IP address” field and the “master setting time stamp” field in the management information table is an example of an instruction for suspending the distribution of the setting values. Further, the computer 100-M represented by the IP address in the “active setting IP address” field is the computer in which the IP address in the “active setting IP address” field is allocated to the LAN I/F 105. When the computer 100-M receives the request, the computer 100-M deletes each value stored in the “master setting IP address” field and the “master setting time stamp” field in the management information table stored in the Flash EEPROM 107. As a result, the state of the management information table in the computer 100-M which receives the request is the state as illustrated in FIG. 8. It is noted here that the BMC 104 performs the processes in OP302 and OP303 as an example of a third instruction process for transmitting a third instruction for suspending the distributing of a sixth setting value to a third information processing apparatus when a third obtaining process obtains the sixth setting value before a second distribution process distributes a fifth setting value.

In OP304, the BMC 104 of the master computer 100-N stores each value stored in the “master setting IP address” field and the “master setting time stamp” field in the management information table in the in the “active setting IP address” field and the “active setting time stamp” field. FIG. 11 illustrates an example of a state in which each value is stored in the management information table in OP304. As illustrated in FIG. 11, the same IP address is stored in the “master setting IP address” field and the “active setting IP address” field in the management information table in the master computer 100-N. In addition, the same time is stored in the “master setting time stamp” field and the “active setting time stamp” field.

Since the processes in OP305 to OP309 are the same as the processes in OP103 to OP107 in FIG. 4, the details of the processes in OP305 to OP309 are omitted here. Therefore, the computer 100-M performs the processes in the flowchart to become a new master computer in place of the computer 100-M. In addition, when the processes in OP302 are performed, the old master computer 100-M is not a master computer any longer. Thus, a situation in which a plurality of computers become master computers does not occur in the present embodiment. And the new master computer 100-N distributes the BIOS setting values and the BMC setting values to the other computers in the information processing system 1.

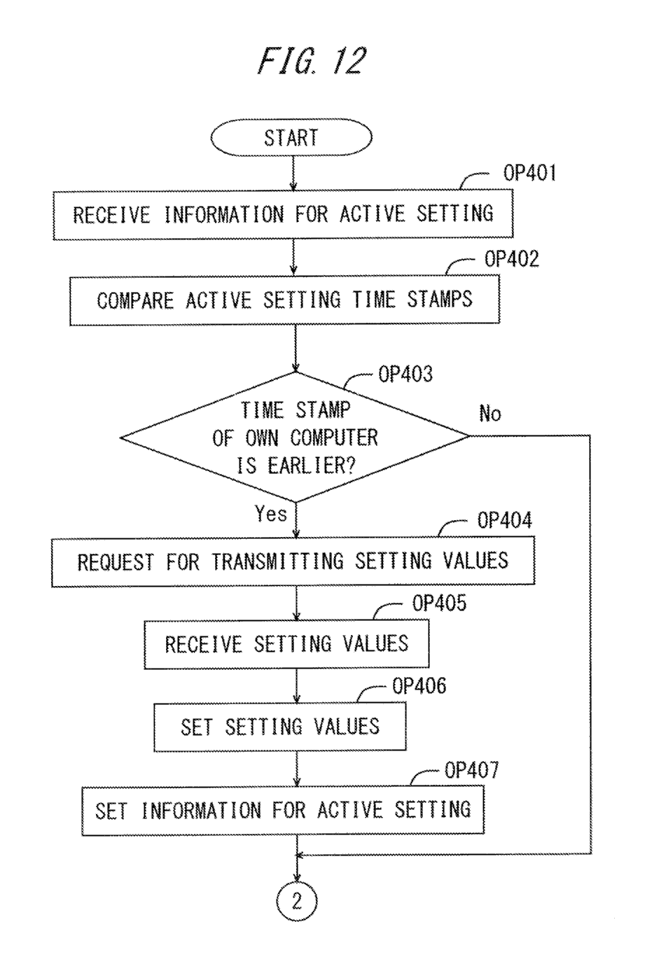

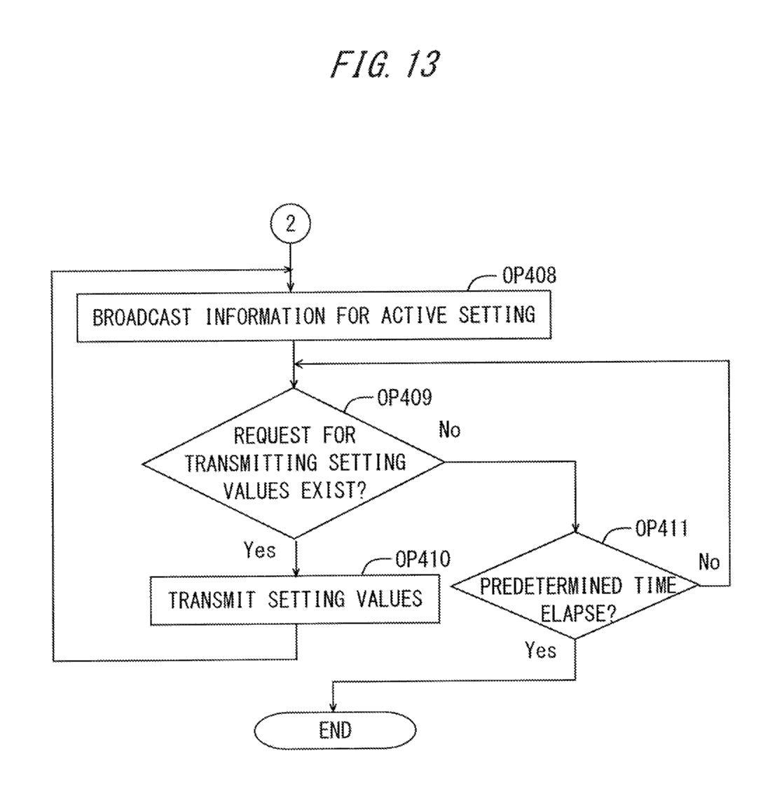

Next, the descriptions are provided with reference to the flowchart in FIGS. 12 and 13 regarding the processes performed by the computer 100-N when the computer 100-N in which BIOS setting values and BMC setting values are set receives information for active setting broadcasted from the computer 100-M. It is noted that “2” in FIG. 12 is connected with “2” in FIG. 13. It is assumed here that each value stored in the management information table in the computer 100-N is as illustrated in FIG. 8 when the computer 100-N initiates the processes in the flowchart in FIGS. 12 and 13. Therefore, the values stored in the “master setting IP address” field and the “master setting time stamp” field in the management information table stored in the Flash EEPROM 107 of the computer 100-N are “None”. In addition, an IP address and time are stored in the “active setting IP address” field and the “active setting time stamp” field, respectively.

When the computer 100-N receives the information for active setting broadcasted from the computer 100-M, the process of the BMC 104 of the computer 100-N proceeds to OP402. It is noted here that the BMC 104 performs the processes in OP401 as an example of a first receiving process for receiving information of second time corresponding to a second setting value from a second information processing apparatus of a plurality of information processing apparatuses which distributes the second setting value. In OP402, the BMC 104 compares the time of the active setting time stamp indicated by the received information for active setting with the time currently stored in the “active setting time stamp” field in the management information table stored in the Flash EEPROM 107. It is noted that the BMC 104 performs a first determination process for determining whether first time is earlier than second time.

When the time stored in the “active setting time stamp” field in the management information table is earlier than the time of the active setting time stamp indicated by the received information for active setting (OP403: Yes), the process of the BMC 104 proceeds to OP404. On the other hand, when the time stored in the “active setting time stamp” field in the management information table is more recent than the time of the active setting time stamp indicated by the received information for active setting (OP403: No), the process of the BMC 104 proceeds to OP408.

In OP404, the BMC 104 uses the IP address of the active setting IP address indicated by the received information for active setting to request the computer 100-M which transmits the information for active setting for the transmission of the BIOS setting values and the BMC setting values. And the BMC 104 receives the BIOS setting values and the BMC setting values from the computer 100-M (OP405) and the process of the BMC 104 proceeds to OP406. It is noted here that the BMC 104 performs the processes in OP403 to OP405 as an example of a first obtaining process for obtaining a second setting value from a second information processing apparatus when a first determination process determines that first time is earlier than second time.

In OP406, the BMC 104 stores the BIOS setting values and the BMC setting values received in OP405 in the CMOS ROM 101 and the Flash EEPROM 107, respectively. And the BMC 104 stores values in the information for active setting in the management information table stored in the EEPROM 107, that is the “active setting IP address” field and the “active setting time stamp” field. It is noted here that the BMC 104 performs the processes in OP406 as an example of a first setting process for setting an obtained second setting value in place of a first setting value in a first information processing apparatus.

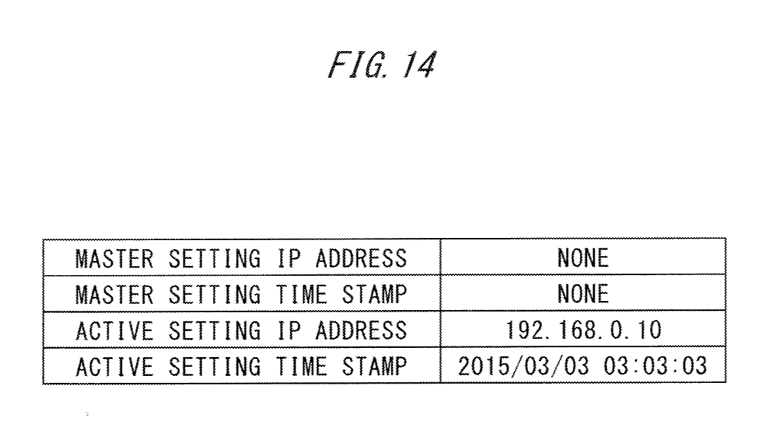

Specifically, the same values as the values stored in the “active setting IP address” field and the “active setting time stamp” field in the computer 100-M which transmits the BIOS setting values and the BMC setting values to the computer 100-N are stored in the “active setting IP address” field and the “active setting time stamp” field in the management information table in the computer 100-N. FIG. 14 illustrates an example of a management information table in the computer 100-N in which the BIOS setting values and the BMC setting values received in OP405 are set. Since the values stored in the “active setting IP address” field and the “active setting time stamp” field in the management information table as illustrated in FIG. 8 are updated as illustrated in FIG. 14, the BIOS setting values and the BMC setting values in the computer 100-N have been updated.

Since the processes in OP408 to OP411 are the same as the processes in OP104 to OP107 in FIG. 4, the details of the processes in OP408 to OP411 are omitted here. Therefore, the computers 100-N which are not master computers perform the processes in the flowchart to set the BIOS setting values and the BMC setting values which are set in the master computer 100-M in the own computers 100-N. In addition, the computer 100-N distributes the BIOS setting values and the BMC setting values to the other computers in the information processing system 1. As a result, the BIOS setting values and the BMC setting values which are set in the master computer 100-M are set in the computers in the information processing system 1.

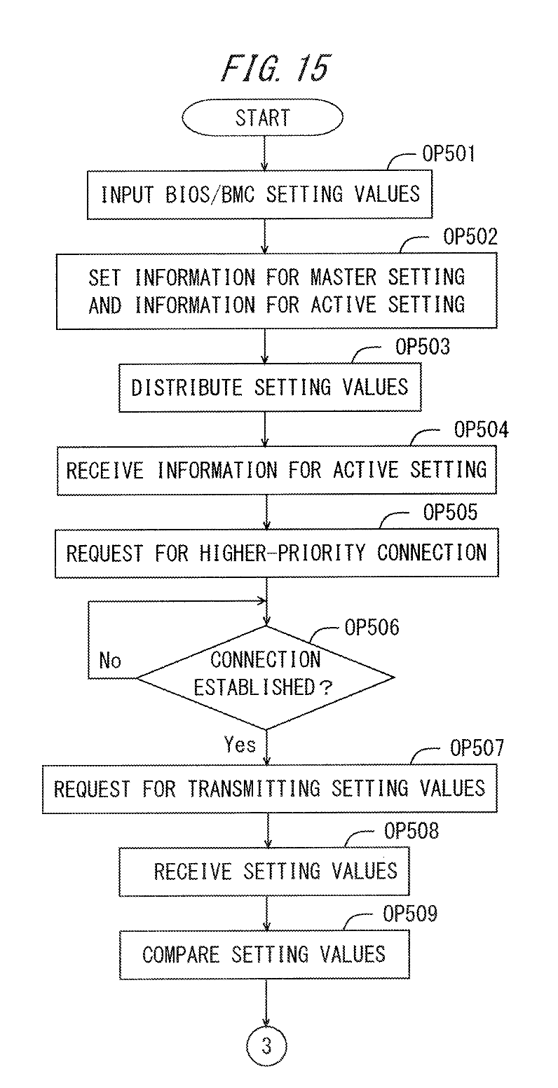

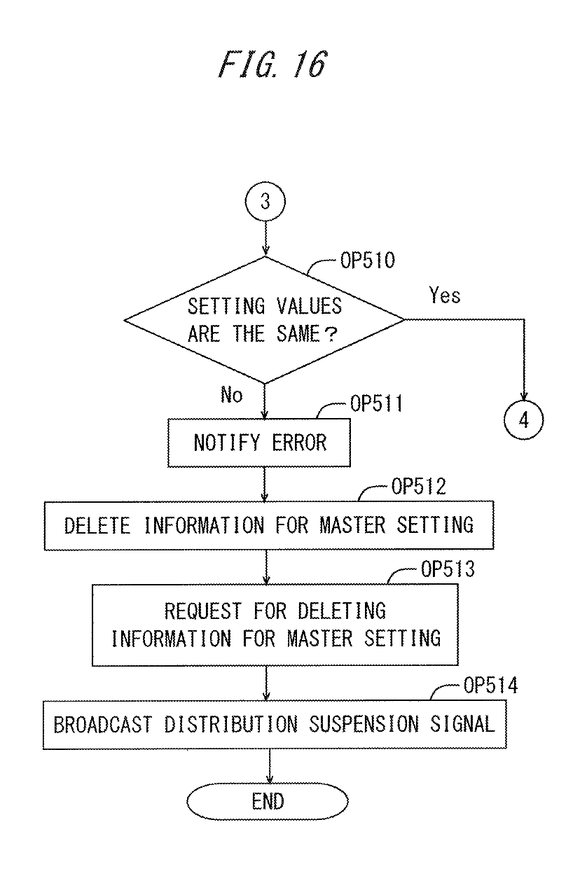

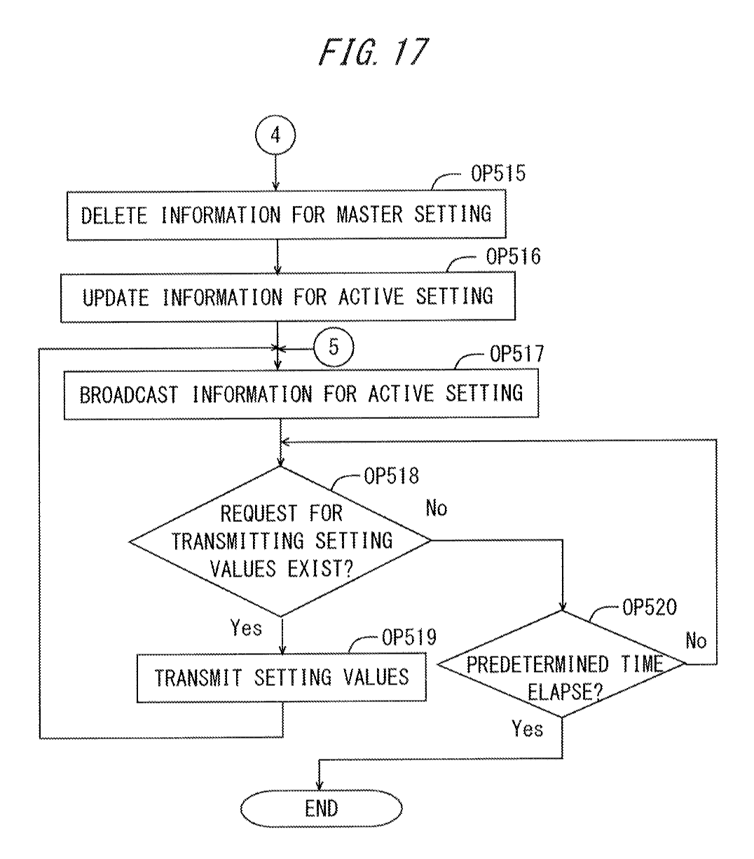

Next, the processes performed by the computer 100-N when the computer 100-N is a master computer, the computer 100-M becomes a master computer and then the computer 100-N receives information for active setting from the computer 100-M are described with reference to FIGS. 15 to 17. It is noted that “3” in FIG. 15 is connected with “3” in FIG. 16 and “4” in FIG. 16 is connected with “4” in FIG. 17. It is assumed here that each value stored in the management information table in the computer 100-N is as illustrated in FIG. 18 when the computer 100-N initiates the processes in the flowchart in FIGS. 15 to 17. Therefore, an IP address or time is stored in the management information table stored in the Flash EEPROM 107 of the computer 100-N as illustrated in FIG. 18.

In addition, it is assumed here that when the state of the management information table in the computer 100-N is as illustrated in FIG. 18, the user of the information processing system 1 input BIOS setting values and BMC setting values into another computer 100-M. In this case, each value is stored in the management information table of the new master computer 100-M as illustrated in FIG. 19.

In OP501, the user of the information processing system 1 inputs the BIOS setting values and the BMC setting values into the computer 100-N. Next, the BMC 104 of the computer 100-N sets the information for master setting and the information for active setting in the management information table stored in the Flash EEPROM 107 (OP502). In addition, the BMC 104 performs the distribution of the BIOS setting values and the BMC setting values set in the own computer 100-N (OP503). It is noted that the BMC 104 of the computer 100-N performs the processes in OP503 as an example of a first distribution process for distributing a third setting value. Then, the computer 100-N receives in OP504 the information for active setting broadcasted from the new master computer 100-M. And the BMC 104 of the computer 100-N uses the IP address indicated by the active setting IP address in the received information for active setting to request the new master computer 100-M for establishing a higher-priority connection with the computer 100-N (OP505). It is noted here that the higher-priority connection is a connection in which the requested computer gives more priority to the connection with the requesting computer than to the current connection.

The requested computer 100-M preferentially establishes the connection with the requesting computer 100-N. In addition, the BMC 104 of the requesting computer 100-N determines whether the connection with the requested computer 100-M is established (OP506). When the BMC 104 determines that the connection with the requested computer 100-M is established (OP506: Yes), the process of the BMC 104 proceeds to OP507. On the other hand, the BMC 104 determines that the connection with the requested computer 100-M is not established (OP506: No), the BMC repeats the processes in OP506.

In OP507, the BMC 104 requests the computer 100-M with the connection is established for transmitting the BIOS setting values and the BMC setting values set in the computer 100-M to the computer 100-N. And the BMC 104 receives the BIOS setting values and the BMC setting values (OP508) and the process of the BMC 104 proceeds to OP509. It is noted here that the BMC 104 of the computer 100-N performs the processes in OP507 and OP508 as an example of a second obtaining process for obtaining a fourth setting value distributed from a fourth information processing apparatus of a plurality of information processing apparatuses.

In OP509, the BMC 104 compares the BIOS setting values and the BMC setting values received in OP508 with the BIOS setting values and the BMC setting values currently set in the computer 100-N. When the BIOS setting values and the BMC setting values received in OP508 with the BIOS setting values and the BMC setting values currently set in the computer 100-N are the same values (OP510: Yes), the process of the BMC 104 proceeds to OP515. On the other hand, when the BIOS setting values and the BMC setting values received in OP508 with the BIOS setting values and the BMC setting values currently set in the computer 100-N are not the same values (OP510: No), the process of the BMC 104 proceeds to OP511. It is noted here that the BMC 104 of the computer 100-N performs the processes in OP509 and OP510 as an example of a second determination process for determining whether a third setting value is the same as a fourth setting value.

When the BIOS setting values and the BMC setting values received in OP508 with the BIOS setting values and the BMC setting values currently set in the computer 100-N are not the same values, different BIOS setting values and different BMC setting values are set in the two computers. It is noted that information indicating the old and new values between the setting values such as version information is not included in the BIOS setting values and the BMC setting values. Therefore, when a computer in the information processing system 1 receives BIOS setting values and BMC setting values from each master computer, the computer cannot determine which BIOS setting values and BMC setting values should be distributed. As a result, there may be a case in which the same BIOS setting values and the same BMC setting values cannot be set in the computers 100 in the information processing system 1. In the present embodiment, two master computers in the information processing system 1 perform processes for deleting the information for master setting in the master computers. In addition, the computers 100 suspend the automatic distribution of the BIOS setting values and the BMC setting values.

In OP511, the BMC 104 displays an error on a display device (not illustrated) connected with the computer 100-N notifying that there are master computers in which different BIOS setting values and different BMC setting values are set. The error can include the information of the IP addresses of the master computers and the setting values set in the master computers. In addition, the BMC 104 deletes the information for master setting, that is each value in the “master setting IP address” field and the “master setting time stamp” field in the management information table stored in the EEPROM 107 of the computer 100-N (OP512). Further, the BMC 104 requests the counterpart master computer 100-M for deletion of the information for master setting (OP513). It is noted here that the BMC 104 of the computer 100-N performs the processes in OP512 and OP513 as an example of a first distribution process for suspending the distributing of a third setting value when a second determination process determines that the third setting value is not the same as a fourth setting value and as an example of a first instruction process for transmitting a first instruction for suspending the distributing of the fourth setting value to a fourth information processing apparatus.

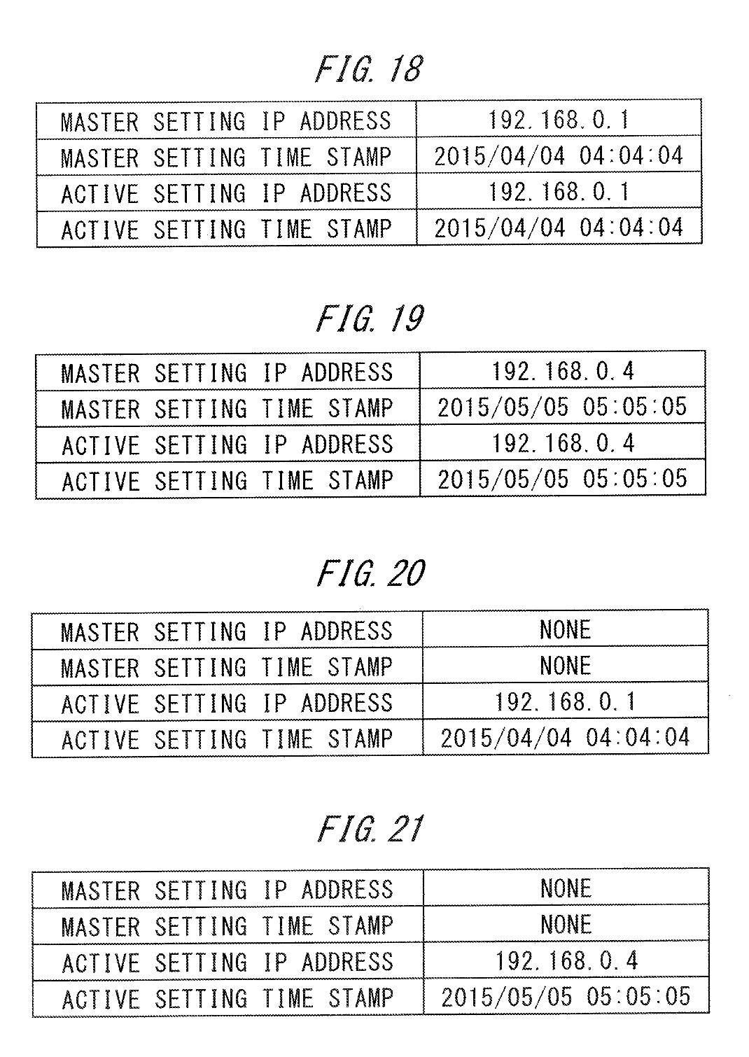

FIGS. 20 and 21 illustrate examples of management information tables of the computer 100-N and 100-M in which the information for master setting is deleted in OP512 and OP513. The state of the management information table the computer 100-N as illustrated in FIG. 18 becomes the state as illustrated in FIG. 20 after the processes in OP512 are performed. In addition, the state of the management information table the computer 100-M as illustrated in FIG. 19 becomes the state as illustrated in FIG. 21 after the processes in OP513 are performed.

In addition, when the BMC 104 performs the processes OP511 to OP513, the BMC 104 broadcasts a signal for suspending the distribution of the BIOS setting values and the BMC setting values to the computers 100 in the information processing system 1 via the LAN I/F 105 (OP514). It is noted here that the BMC 104 of the computer 100-N performs the processes in OP514 as an example of a second instruction process for transmitting a second instruction for suspending the distributing of a third setting values and a fourth setting values to a fifth information processing apparatus when a second determination process determines that the third setting value is not the same as the fourth setting value. When the computers 100 receive the broadcasted signal for suspending the distribution, the computers 100 suspends the distribution of the BIOS setting values and the BMC setting values. When the BMC 104 completes the processes in OP514, the BMC 104 terminates the processes in the flowchart.

Next, the details of the case in which the process of the BMC 104 proceeds from OP510 to OP515 are described below. There may be a case in which the same BIOS setting values and the same BMC setting values are set in both of the computers 100-N and 100-M. In this case, the process of the BMC 104 proceeds from OP510 to OP515.

In OP515, the BMC 104 of the computer 100-N deletes the information for master setting in the management information table stored in the Flash EEPROM 107, that is each value stored in the “master setting IP address” field and the “master setting time stamp” field. And the BMC 104 uses the information for active setting received in OP504, that is the information for active setting set in the management information table in the new master computer 100-M to update the management information table stored in the Flash EEPROM 107 (OP516). As a result, each value stored in the “active setting IP address” field and the “active setting time stamp” field in the management information table is the same as each value stored in the management information table in the computer 100-M. Since the processes in OP517 to OP520 are the same as the processes in OP408 to OP411 as described above, the details of the processes in OP217 to OP520 are omitted here. In addition, it is noted here that the BMC 104 of the computer 100-N performs the processes in OP515 to OP520 as an example of a first distribution process for suspending the distributing of a third setting value and distributing a fourth setting value when a second determination process determines that the third setting value is the same as the fourth setting value.

When BIOS setting values and BMC setting values are set indifferent computers in the information processing system 1, each of the different computers becomes a master computer and the processes as described above are performed in the information processing system 1, the distributions of the BIOS setting values and the BMC setting values from the master computers are suspended. The user of the information processing system 1 receives an error notified in OP511 to confirm that there are a plurality of master computers in the information processing system 1. Therefore, the user can check the BIOS setting values and the BMC setting values set in each master computer. As a result, the user can input appropriate BIOS setting values and appropriate BMC setting values into any one of the computers 100 to initiate the distribution of the appropriate BIOS setting values and the appropriate BMC setting values to each computer in the information processing system 1.

Although specific embodiments are described above, the configurations of the information processing system etc. described and illustrated in each configuration example can be arbitrarily modified and/or combined. For example, although BIOS setting values and BMC setting values are commonly set in the computers in the information processing system 1 in the embodiments as described above, various setting values other than the BIOS setting values and the BMC setting values can be set in the computers by the processes as described above. In addition, although an IP address allocated to the LAN I/F 105 is used as information for identifying each computer 100, any other identification information can be used instead of the IP address.

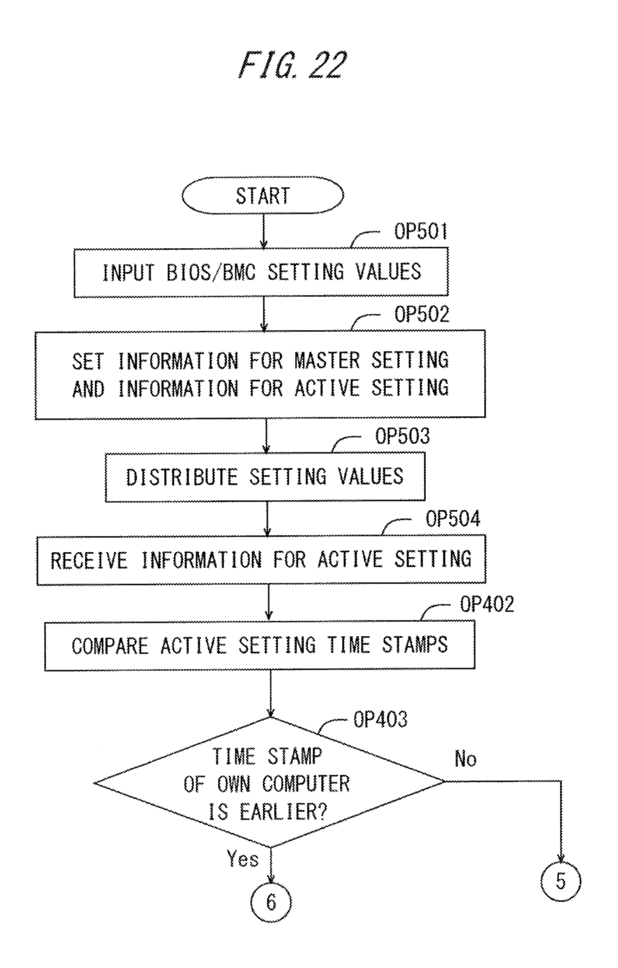

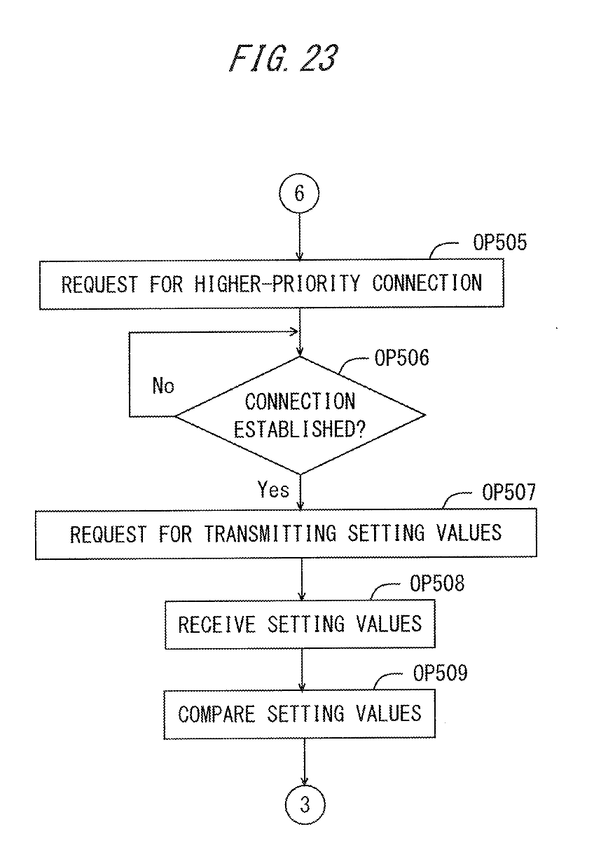

For example, the processes as illustrated in FIGS. 22 and 23 can be performed as a variation example of the processes in OP501 to OP509 as illustrated in FIG. 15. In the processes in FIGS. 22 and 23, the processes in OP402 and OP403 are added between the processes in OP504 and OP504. It is noted that “5” in FIG. 22 is connected with “5” in FIG. 17, “6” in FIG. 22 is connected with “6” in FIG. 23 and “3” in FIG. 22 is connected with “3” in FIG. 16. It is assumed in the variation example that different computers 100-N and 100-M become master computers in the information processing system 1. In addition, it is assumed that the user of the information processing system 1 inputs BIOS setting values and BMC setting values into the computer 100-M after the master computer 100-N distributes BIOS setting values and BMC setting values set in the master computer 100-N. In the variation example, the computer 100-N compares the active setting time stamp in the information for active setting received from the computer 100-M with the active setting time stamp stored in the own computer 100-N. When the computer 100-N confirms that the active setting time stamp stored in the own computer 100-N is earlier than the active setting time stamp in the information for active setting received from the computer 100-M, the computer 100-N determines whether the setting values distributed by the computer 100-N are the same as the setting values distributed by the computer 100-M.

Since the processes in OP402, OP403 and OP501 to OP509 are the same as the processes as described in the above embodiment, the details of the processes in OP402, OP403 and OP501 to OP509 are omitted here. In the variation example, the BMC 104 of the computer 100-N performs the processes in OP502 as an example of a second storing process for storing information of third time corresponding to a third setting value. In addition, the BMC 104 of the computer 100-N performs the processes in OP504 as an example of a second receiving process for receiving information of fourth time corresponding to a fourth setting value from a fourth information processing apparatus. Further, the BMC 104 of the computer 100-N performs the processes in OP402 as an example of a second determination process for determining whether the third setting value is the same as the fourth setting value. Moreover, the BMC 104 of the computer 100-N performs the processes in OP507 and OP508 as an example of a second obtaining process for obtaining the fourth setting value distributed from a second information processing apparatus in the information processing system.

It is assumed in the variation example that there are two master computers in which the same BIOS setting values and the same BMC setting values are set in the information processing system 1. In this case, when the processes in FIG. 22 are performed, one of the two master computers in which the time when the BIOS setting values and the BMC setting values are set is earlier than the time when the BIOS setting values and the BMC setting values are set in the other master computer continues to be a master computer. In addition, the other master computer abandons the role of the master computer. As a result, the number of master computers for distributing the BIOS setting values and the BMC setting values in the information processing system 1 is one. Therefore, each computer 100 in the information processing system 1 can commonly set the BIOS setting values and the BMC setting values distributed from the one master computer.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

According to one aspect, it is provided an information processing system in which setting values can commonly be set in a plurality of information processing apparatuses.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing system including a plurality of information processing apparatuses each of which distributes a setting value, wherein
a first information processing apparatus of the plurality of information processing apparatuses comprises:
a first processor; and
first memory storing instructions for causing the first processor to execute:
a first storing process for storing information of first time corresponding to a first setting value distributed to the first information processing apparatus;
a first receiving process for receiving information of second time corresponding to a second setting value from a second information processing apparatus of the plurality of information processing apparatuses which distributes the second setting value;
a first determination process for determining whether the first time is earlier than the second time;
a first obtaining process for obtaining the second setting value from the second information processing apparatus when the first determination process determines that the first time is earlier than the second time; and
a first setting process for setting the obtained second setting value in place of the first setting value in the first information processing apparatus.

2. An information processing system including a plurality of information processing apparatuses each of which distributes a setting value, wherein
a third information processing apparatus of the plurality of information processing apparatuses comprises:
a third processor; and
third memory storing instructions for causing the third processor to execute:
a first distribution process for distributing a third setting value;
a second obtaining process for obtaining a fourth setting value distributed from a fourth information processing apparatus of the plurality of information processing apparatuses; and
a second determination process for determining whether the third setting value is the same as the fourth setting value,
wherein when the second determination process determines that the third setting value is the same as the fourth setting value, the first distribution process suspends the distributing of the third setting value and distributes the fourth setting value.

3. The information processing system according to claim 2, wherein the third processor further executes:
a second storing process for storing information of third time corresponding to the third setting value;
a second receiving process for receiving information of fourth time corresponding to the fourth setting value from the fourth information processing apparatus;
a third determination process for determining whether the third time is earlier than the fourth time;
wherein when the third determination process determines that the third time is earlier than the fourth time, the second obtaining process obtains the fourth setting value from the fourth information processing apparatus.

4. The information processing system according to claim 2, wherein the third processor further executes:
a first instruction process for transmitting an instruction to the fourth information processing apparatus;
wherein when the second determination process determines that the third setting value is not the same as the fourth setting value, the first distribution process suspends the distributing of the third setting value and the first instruction process transmits a first instruction for suspending the distributing of the fourth setting value to the fourth information processing apparatus.

5. The information processing system according to claim 4, wherein the third processor further executes:
a second instruction process for transmitting an instruction to a fifth information processing apparatus of the plurality of information processing apparatuses,
wherein when the second determination process determines that the third setting value is not the same as the fourth setting value, the second instruction process transmits a second instruction for suspending the distributing of the third setting values and the fourth setting values to the fifth information processing apparatus.

6. The information processing system according to claim 5, wherein the third processor further executes:
a second distribution process for distributing a fifth setting value;
a third obtaining process for obtaining a sixth setting value distributed from a sixth information processing apparatus of the plurality of information processing apparatuses; and
a third instruction process for transmitting an instruction to the sixth information processing apparatus,
wherein when the third obtaining process obtains the sixth setting value from the sixth information processing apparatus before the second distribution process distributes the fifth setting value, the third instruction process transmits a third instruction for suspending the distributing of the sixth setting value to the sixth information processing apparatus.

7. The information processing system according to claim 3, wherein the first distribution process transmits the information of the third time to a seventh information processing apparatus, and distributes the third setting value to the seventh information processing apparatus when the first information processing apparatus receives a response for the information of the third time from the seventh information processing apparatus.

8. An information processing apparatus included in an information processing system which distributes a setting value, the information processing apparatus comprising:
a first processor; and
first memory storing instructions for causing the first processor to execute:
a first storing process for storing information of first time corresponding to a first setting value distributed to the information processing apparatus;
a first receiving process for receiving information of second time corresponding to a second setting value from a first information processing apparatus in the information processing system which distributes the second setting value;
a first determination process for determining whether the first time is earlier than the second time;
a first obtaining process for obtaining the second setting value from the first information processing apparatus when the first determination process determines that the first time is earlier than the second time; and
a first setting process for setting the obtained second setting value in place of the first setting value in the own information processing apparatus.

9. An information processing apparatus included in an information processing system which distributes a setting value, the information processing apparatus comprising:
a third processor; and
third memory storing instructions for causing the third processor to execute:
a first distribution process for distributing a third setting value;
a second obtaining process for obtaining a fourth setting value distributed from a second information processing apparatus in the information processing system; and
a second determination process for determining whether the third setting value is the same as the fourth setting value,
wherein when the second determination process determines that the third setting value is the same as the fourth setting value, the first distribution process suspends the distributing of the third setting value and distributes the fourth setting value.

10. The information processing apparatus according to claim 9, wherein the third processor further executes:
a second storing process for storing information of third time corresponding to the third setting value;
a second receiving process for receiving information of fourth time corresponding to the fourth setting value from the second information processing apparatus;
a third determination process for determining whether the third time is earlier than the fourth time;
wherein when the third determination process determines that the third time is earlier than the fourth time, the second obtaining process obtains the fourth setting value from the second information processing apparatus.

11. The information processing apparatus according to claim 9, wherein the third processor further executes:
a first instruction process for transmitting an instruction to the second information processing apparatus;
wherein when the second determination process determines that the third setting value is not the same as the fourth setting value, the first distribution process suspends the distributing of the third setting value and the first instruction process transmits a first instruction for suspending the distributing of the fourth setting value to the fourth information processing apparatus.

12. The information processing apparatus according to claim 11, wherein the third processor further executes:
a second instruction process for transmitting an instruction to a fifth information processing apparatus in the information processing system,
wherein when the second determination process determines that the third setting value is not the same as the fourth setting value, the second instruction process transmits a second instruction for suspending the distributing of the third setting values and the fourth setting values to the fifth information processing apparatus.

13. The information processing apparatus according to claim 12, wherein the third processor further executes:
a second distribution process for distributing a fifth setting value;
a third obtaining process for obtaining a sixth setting value distributed from a third information processing apparatus in the information processing system; and
a third instruction process for transmitting an instruction to the third information processing apparatus,
wherein when the third obtaining process obtains the sixth setting value before the second distribution process distributes the fifth setting value, the third instruction process transmits a third instruction for suspending the distributing of the sixth setting value to the third information processing apparatus.

14. The information processing apparatus according to claim 10, wherein the first distribution process transmits the information of the third time to a fourth information processing apparatus, and distributes the third setting value to the fourth information processing apparatus when a response for the information of the third time is received from the fourth information processing apparatus.

15. A method of controlling an information processing apparatus included in an information processing system which distributes a setting value, the method comprising:
causing a processor of the information processing apparatus to execute:
a first storing process for storing information of first time corresponding to a first setting value distributed to the first information processing apparatus;
a first receiving process for receiving information of second time corresponding to a second setting value from a second information processing apparatus of the plurality of information processing apparatuses which distributes the second setting value;
a first determination process for determining whether the first time is earlier than the second time;
a first obtaining process for obtaining the second setting value from the second information processing apparatus when the first determination process determines that the first time is earlier than the second time; and
a first setting process for setting the obtained second setting value in place of the first setting value in the first information processing apparatus.

16. A method of controlling an information processing apparatus included in an information processing system which distributes a setting value, the method comprising:
causing a processor of the information processing apparatus to execute:
a first distribution process for distributing a third setting value;
a second obtaining process for obtaining a fourth setting value distributed from a fourth information processing apparatus of the plurality of information processing apparatuses; and
a second determination process for determining whether the third setting value is the same as the fourth setting value,
wherein when the second determination process determines that the third setting value is the same as the fourth setting value, the first distribution process suspends the distributing of the third setting value and distributes the fourth setting value.

17. The method according to claim 16, wherein the processor further executes:
a second storing process for storing information of third time corresponding to the third setting value;
a second receiving process for receiving information of fourth time corresponding to the fourth setting value from the fourth information processing apparatus;
a third determination process for determining whether the third time is earlier than the fourth time;
wherein when the third determination process determines that the third time is earlier than the fourth time, the second obtaining process obtains the fourth setting value from the fourth information processing apparatus.

18. The method according to claim 16, wherein the processor further executes:
a first instruction process for transmitting an instruction to the fourth information processing apparatus;
wherein when the second determination process determines that the third setting value is not the same as the fourth setting value, the first distribution process suspends the distributing of the third setting value and the first instruction process transmits a first instruction for suspending the distributing of the fourth setting value to the fourth information processing apparatus.

19. The method according to claim 18, wherein the processor further executes:
a second instruction process for transmitting an instruction to a fifth information processing apparatus of the plurality of information processing apparatuses,
wherein when the second determination process determines that the third setting value is not the same as the fourth setting value, the second instruction process transmits a second instruction for suspending the distributing of the third setting values and the fourth setting values to the fifth information processing apparatus.

20. The method according to claim 19, wherein the processor further executes:
a second distribution process for distributing a fifth setting value;
a third obtaining process for obtaining a sixth setting value distributed from a sixth information processing apparatus of the plurality of information processing apparatuses; and
a third instruction process for transmitting an instruction to the sixth information processing apparatus,
wherein when the third obtaining process obtains the sixth setting value from the sixth information processing apparatus before the second distribution process distributes the fifth setting value, the third instruction process transmits a third instruction for suspending the distributing of the sixth setting value to the sixth information processing apparatus.

21. The method according to claim 17, wherein the first distribution process transmits the information of the third time to a seventh information processing apparatus, and distributes the third setting value to the seventh information processing apparatus when the first information processing apparatus receives a response for the information of the third time from the seventh information processing apparatus.

22. A non-transitory computer-readable recording medium storing a program that causes a computer in an information processing apparatus in an information processing system which distributes a setting value to execute a process, the process comprising:
a first storing process for storing information of first time corresponding to a first setting value distributed to the first information processing apparatus;
a first receiving process for receiving information of second time corresponding to a second setting value from a second information processing apparatus of the plurality of information processing apparatuses which distributes the second setting value;
a first determination process for determining whether the first time is earlier than the second time;
a first obtaining process for obtaining the second setting value from the second information processing apparatus when the first determination process determines that the first time is earlier than the second time; and
a first setting process for setting the obtained second setting value in place of the first setting value in the first information processing apparatus.

23. A non-transitory computer-readable recording medium storing a program that causes a computer in an information processing apparatus in an information processing system which distributes a setting value to execute a process, the process comprising:
a first distribution process for distributing a third setting value;
a second obtaining process for obtaining a fourth setting value distributed from a fourth information processing apparatus of the plurality of information processing apparatuses; and
a second determination process for determining whether the third setting value is the same as the fourth setting value,
wherein when the second determination process determines that the third setting value is the same as the fourth setting value, the first distribution process suspends the distributing of the third setting value and distributes the fourth setting value.

24. The non-transitory computer-readable recording medium according to claim 23, wherein the process further comprises:
a second storing process for storing information of third time corresponding to the third setting value;
a second receiving process for receiving information of fourth time corresponding to the fourth setting value from the fourth information processing apparatus;
a third determination process for determining whether the third time is earlier than the fourth time;
wherein when the third determination process determines that the third time is earlier than the fourth time, the second obtaining process obtains the fourth setting value from the fourth information processing apparatus.

25. The non-transitory computer-readable recording medium according to claim 23, wherein the process further comprises:
a first instruction process for transmitting an instruction to the fourth information processing apparatus;
wherein when the second determination process determines that the third setting value is not the same as the fourth setting value, the first distribution process suspends the distributing of the third setting value and the first instruction process transmits a first instruction for suspending the distributing of the fourth setting value to the fourth information processing apparatus.

26. The non-transitory computer-readable recording medium according to claim 25, wherein the process further comprises:
a second instruction process for transmitting an instruction to a fifth information processing apparatus of the plurality of information processing apparatuses,
wherein when the second determination process determines that the third setting value is not the same as the fourth setting value, the second instruction process transmits a second instruction for suspending the distributing of the third setting values and the fourth setting values to the fifth information processing apparatus.

27. The non-transitory computer-readable recording medium according to claim 26, wherein the process further comprises:
a second distribution process for distributing a fifth setting value;
a third obtaining process for obtaining a sixth setting value distributed from a sixth information processing apparatus of the plurality of information processing apparatuses; and
a third instruction process for transmitting an instruction to the sixth information processing apparatus,
wherein when the third obtaining process obtains the sixth setting value from the sixth information processing apparatus before the second distribution process distributes the fifth setting value, the third instruction process transmits a third instruction for suspending the distributing of the sixth setting value to the sixth information processing apparatus.

28. The non-transitory computer-readable recording medium according to claim 24, wherein the first distribution process transmits the information of the third time to a seventh information processing apparatus, and distributes the third setting value to the seventh information processing apparatus when the first information processing apparatus receives a response for the information of the third time from the seventh information processing apparatus.
